(19) United States
(12) Patent Application Publication
(10) Pub. No.: US 2014/0188307 A1
(43) Pub. Date: Jul. 3, 2014

(54) SIGNAL COMMUNICATION SYSTEM AND METHOD FOR A VEHICLE SYSTEM

(71) Applicant: GENERAL ELECTRIC COMPANY, Schenectady, NY (US)

(72) Inventors: Jared Klineman Cooper, Melbourne, FL (US); Robert James Foy, Melbourne, FL (US); David Michael Peltz, Melbourne, FL (US); Eugene A. Smith, Melbourne, FL (US); Steven Andrew Kellner, Melbourne, FL (US); Brian William Schroeck, Melbourne, FL (US); Keith Gilbertson, Grain Valley, MO (US)

(73) Assignee: GENERAL ELECTRIC COMPANY, Schenectady, NY (US)

(21) Appl. No.: 13/729,446

(22) Filed: Dec. 28, 2012

(51) Int. Cl. B61C 17/12; G06F 19/00

(52) U.S. Cl. CPC B61C 17/12; G06F 19/00
USPC 701/2; 701/36

(57) ABSTRACT

A communication system includes a first wireless communication device disposed onboard a vehicle system having two or more propulsion-generating vehicles that are mechanically interconnected with each other. The communication system also includes a controller configured to be disposed onboard the vehicle system and operatively connected with the first wireless communication device in order to control operations of the device. The controller is configured to direct the first wireless communication device to switch between operating in an off-board communication mode and an onboard communication mode. When the first wireless communication device is operating in the off-board communication mode, the device is configured to receive remote data signals from a location that is disposed off-board of the vehicle system. When the first wireless communication device is operating in the onboard communication mode, the device is configured to communicate local data signals between the propulsion-generating vehicles of the vehicle system.

### BACKGROUND

Embodiments of the subject matter herein relate generally to signal communication systems and methods for a vehicle system.

Some known vehicle systems include multiple vehicles connected together so that the vehicles can travel together. Such vehicle systems can be referred to as consists. For example, rail vehicle consists may include two or more locomotives (or other powered vehicles capable of self-propulsion) and one or more railcars (incapable of self-propulsion) connected together. The vehicles may communicate with each other locally to coordinate the movement of the vehicle system. The vehicles may also communicate with a remote location from the vehicle system.

The local communications between vehicles in the vehicle system may include various signals containing messages relating to a wide range of information, including operation, safety, status, and confirmations, among a host of others. The potentially large number of local communications transmitted between vehicles can congest the available bandwidth used to transmit the signals. Signals may get lost in the transmission, resulting in non-receipt of the contained message. Additionally, some vehicle systems may be configured upon non-receipt of certain communications to automatically shut down for safety reasons so that any potential problems with the vehicle system may be discovered. A shut-down caused by non-receipt of a local signal could result in a long delay before the vehicle system resumes its route.

### BRIEF DESCRIPTION

In one embodiment, a communication system includes a wireless communication device and a controller. The wireless communication device is configured to be disposed onboard a vehicle system having two or more propulsion-generating vehicles that are mechanically interconnected with each other in order to travel along a route together. The controller is configured to be disposed onboard the vehicle system and operatively connected with the wireless communication device in order to control operations of the wireless communication device. The controller is configured to direct the wireless communication device to switch between operating in an off-board communication mode and operating in an onboard communication mode. When the wireless communication device is operating in the off-board communication mode, the wireless communication device is configured to receive remote data signals from a location that is disposed off-board of the vehicle system. When the wireless communication device is operating in the onboard communication mode, the wireless communication device is configured to communicate local data signals between the propulsion-generating vehicles of the vehicle system.

In another embodiment, a method includes directing a wireless communication device configured to be disposed onboard a vehicle system to operate in an off-board communication mode. The vehicle system has two or more propulsion-generating vehicles that are mechanically interconnected with each other in order to travel along a route together. In the off-board communication mode, the wireless communication device is configured to receive remote data signals from a location that is disposed off-board the vehicle system. The method also includes switching the wireless communication device from operating in the off-board communication mode to operating in an onboard communication mode. In the onboard communication mode, the wireless communication device is configured to communicate local data signals between the propulsion-generating vehicles of the vehicle system. The method further includes controlling movement of the vehicle system responsive to receipt of the remote data signals and responsive to receipt of the local data signals.

In a further embodiment, a communication system includes a controller. The controller is configured to be disposed onboard a vehicle system having two or more propulsion-generating vehicles that are mechanically interconnected with each other in order to travel along a route together. The controller is configured to operatively connect with the propulsion-generating vehicles and a wireless communication device. The controller directs the wireless communication device to switch between operating in an off-board communication mode and operating in an onboard communication mode. In the off-board communication mode, the wireless communication device is configured to receive remote data signals from a location that is disposed off-board of the vehicle system. In the onboard communication mode, the wireless communication device is configured to communicate local data signals between the propulsion-generating vehicles of the vehicle system.

In another embodiment, a communication system includes a radio deployed onboard a first rail vehicle of a rail vehicle consist and operative in a first mode of operation and a second mode of operation. The radio is configured when operating in the first mode of operation to communicate at least one of voice signals or data signals between the first rail vehicle and a location off-board the rail vehicle consist using a first frequency bandwidth. The radio is configured when operating in the second mode of operating to wirelessly communicate distributed power signals from the first rail vehicle to one or more remote rail vehicles in the rail vehicle consist using a different, second frequency bandwidth, for at least one of augmenting operating of other onboard wireless devices that are configured to communicate the distributed power signals in the rail vehicle consist or for acting in place of at least one of the other onboard wireless devices.

### BRIEF DESCRIPTION OF THE DRAWINGS

FIG. 1 schematically illustrates a communication system including a vehicle system and an off-board signaling device in accordance with an embodiment.

FIG. 2 schematically illustrates a propulsion-generating vehicle in accordance with an embodiment.

FIG. 3 illustrates a time diagram for operating a wireless communication device according to an embodiment.

FIG. 4 is a flow diagram illustrating a signal communication method according to an embodiment.

### DETAILED DESCRIPTION

One or more embodiments disclosed herein describe a communication system and method used in conjunction with a vehicle system having plural propulsion-generating vehicles. Two or more of the propulsion-generating vehicles include wireless communication devices onboard the propulsion-generating vehicles. A first wireless communication device communicates remote data signals with a location disposed off-board the vehicle system. The remote data signals may be warning signals, such as signals communicated in a positive train control (PTC) system. As such, the first wireless communication device also is referred to as a remote wireless communication device. A second wireless communication device disposed onboard the propulsion-generating vehicles may be configured to communicate local data signals between the propulsion-generating vehicles, and is also referred to as a local wireless communication device. The local data signals may be signals used to control tractive efforts or braking efforts of the propulsion-generating vehicles, such as distributed power (DP) signals.

During operation of the vehicle system, the local wireless communication device communicates local messages between the propulsion-generating vehicles in the vehicle system to coordinate operations of the propulsion-generating vehicles. The remote wireless communication device “listens” for remote data signals sent from off-board locations, such as a dispatch or another vehicle system. The remote wireless communication device can be controlled to switch from an off-board communication mode, where the remote wireless communication device communicates remote data signals, to an onboard communication mode, where the remote wireless communication device communicates local data signals.

In one example, when the remote wireless communication device is not receiving remote data signals, the remote wireless communication device is configured to switch automatically from the off-board communication mode to the onboard communication mode. In the onboard mode, the remote wireless communication device may supplement the local wireless communication device by augmenting the bandwidth provided by the local wireless communication device to communicate local data signals between the propulsion-generating vehicles. The remote wireless communication device can augment the available bandwidth by providing a separate communication data path. However, in an embodiment, even while operating in the onboard communication mode, the remote wireless communication device can “listen” for remote data signals communicated from an off-board source, and may be configured to autonomously revert back to the off-board communication mode upon receiving a remote data signal.

A more particular description of the inventive subject matter briefly described above will be rendered by reference to specific embodiments thereof that are illustrated in the appended drawings. The inventive subject matter will be described and explained with the understanding that these drawings depict only typical embodiments of the inventive subject matter and are not therefore to be considered to be limiting of its scope. Throughout the description of the embodiments, the terms “radio link,” “RF (radio frequency) link,” and “RF communications” and similar terms describe a method of communicating between two nodes in a network, such as a lead and a remote locomotive of a distributed power train. It should be understood that the communications between nodes in the system is not limited to radio or RF systems or the like and is meant to cover all techniques by which messages may be delivered from one node to another or to plural others, including without limitation, magnetic systems, acoustic systems, and optical systems. Likewise, the inventive subject matter is not limited to a described embodiment in which RF links are used between nodes and the various components are compatible with such links

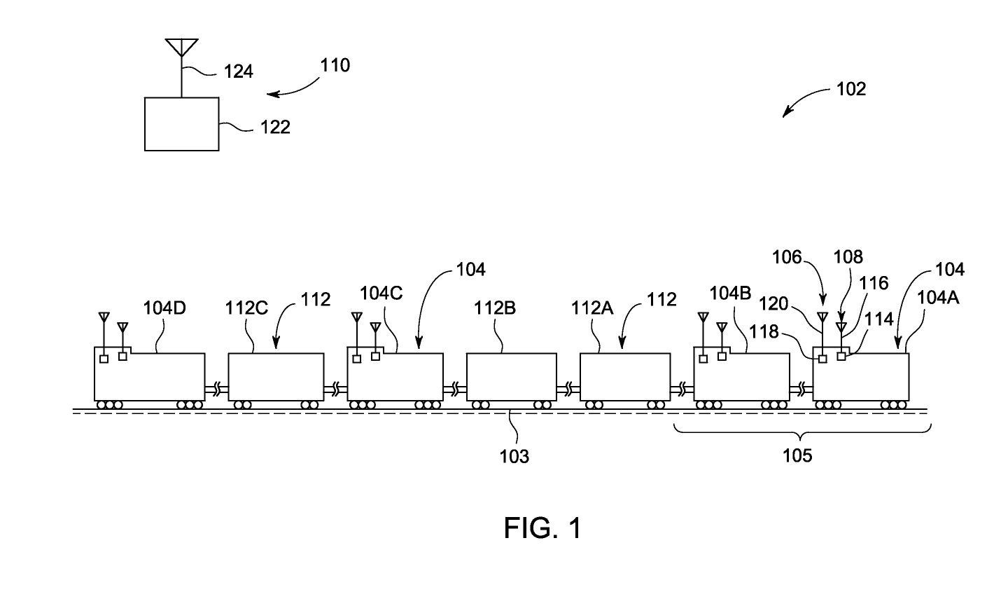

FIG. 1 schematically illustrates a communication system 100 including a vehicle system 102 and an off-board signaling device 110 in accordance with an embodiment. The vehicle system 102, traveling along a route 103, includes two or more propulsion-generating vehicles 104 (e.g., vehicles 104A-D) that are mechanically interconnected with each other in order to travel along the route 103 together. Two or more of the propulsion-generating vehicles 104 may be directly connected to form a group or consist 105, as illustrated in FIG. 1. Additionally, one or more propulsion-generating vehicles 104 may optionally be spaced apart from other propulsion-generating vehicles 104, and directly connected instead to one or more non-propulsion-generating vehicles 112 (e.g., vehicles 112A-C). The non-propulsion-generating vehicles 112 may be configured to carry a load for transport and are propelled along the route 103 by the propulsion-generating vehicles. The number and arrangement of the propulsion-generating vehicles 104 and non-propulsion-generating vehicles 112 illustrated in FIG. 1 is merely an example, as other embodiments of the inventive subject matter may use different vehicle 104, 112 arrangements and/or different numbers of vehicles 104 and/or 112. For example, the vehicle system 102 may include a greater proportion of non-propulsion-generating vehicles 112 to propulsion-generating vehicles 104.

The propulsion-generating vehicles 104 supply motive power and braking action for the vehicle system 102. Tractive and braking efforts for the vehicle system 102 may be coordinated and shared among the propulsion-generating vehicles 104. In one embodiment, one propulsion-generating vehicle 104 is designated as a lead (or active) unit. The lead unit issues command messages to one or more propulsion-generating vehicles 104 designated as remote units. The command messages may be transmitted wirelessly as local data signals from the lead unit to the remote units. The command messages may include, for example, messages ordering the remote units to apply, increase, or decrease tractive efforts or to apply, increase, or decrease braking efforts. In one embodiment, the command messages may be DP commands that coordinate control of tractive effort and/or braking by partitioning the required motive output among the propulsion-generating vehicles 104 in the vehicle system 102. In transmitting the command messages, the lead unit may operate to delegate to each of the remote units or consists a requested motive output. For example, to slow the vehicle system 102, the lead unit may command the remote units to apply braking efforts. The requested motive output commands may vary among the propulsion-generating vehicles 104.

The lead unit may optionally be the front propulsion-generating vehicle 104A in the vehicle system 102. Or, the lead unit may be located elsewhere. In the illustrated arrangement where the lead unit is the front propulsion-generating vehicle 104A, the propulsion-generating vehicles 104C and 104D may be remote units, while vehicle 104B forms a consist with the lead unit 104A. In other embodiments the lead unit may be a propulsion-generating vehicle 104 located away from the front of the vehicle system 102, such as vehicles 104B, 104C, or 104D. It should be noted that all propulsion-generating vehicles 104 may be substantially similar in form, with each having the operative capability to serve as the designated lead unit. For illustrative purposes only, the lead unit will hereafter be referred to as propulsion-generating vehicle 104A, while the remote units will be referred to as 104C-D.

In one embodiment, the vehicle system 102 may be a train configured to operate on rails. In this embodiment, the propulsion-generating vehicles 104 may be locomotives interspersed among a plurality of rail cars (e.g., the non-propulsion vehicles 112) throughout the length of the train to supply motive power and braking action for the train. In other embodiments, the propulsion-generating vehicles 104 may be other off-highway vehicles (e.g., mining vehicles and other vehicles that are not designed for or permitted to travel on public roadways), automobiles (e.g., vehicles that are designed for traveling on public roadways), marine vessels, and the like.

The propulsion-generating vehicles 104 may include two or more wireless communication devices disposed onboard the propulsion-generating vehicle 104, such as a remote wireless communication device 106 and a local wireless communication device 108. The remote wireless communication devices 106 are configured to communicate both remote data signals and local data signals. Data signals as used herein may include audio signals such as voice signals, video signals, digital data signals, and the like. The remote data signals are transmitted from locations off-board the vehicle system 102 (e.g., other vehicle systems, dispatch facilities, wayside transponders, and the like), while the local data signals are transmitted between propulsion-generating vehicles 104 on the vehicle system 102 itself. The remote wireless communication devices 106 may include transceivers 118, antennas 120, and associated circuitry and software. The remote wireless devices 106 include a bandwidth which allows the remote data signals to be transmitted on various frequencies, which allows for simultaneous transmission of multiple control signals. The remote wireless communication devices 106 may be configured with long ranges in order to receive remote data signals sent from remote sources located relatively far away. For example, the remote wireless communication device 106 may have a range up to 40 miles or more. For example, the remote data signals may be transmitted at high frequency ranges (e.g., around 3-30 MHz) and/or very high frequency ranges (e.g., around 30-300 MHz) to allow for such long-range transmission. In an embodiment, the remote wireless communication device 106 may be a radio device (e.g., a 220 MHz radio, a 12R3D radio, or the like), with the ability to receive and send remote and local data signals sent along various frequencies and channels.

In the illustrated embodiment, the remote wireless communication devices 106 on the propulsion-generating vehicles 104 are configured to communicate with an off-board signaling device 110 that is located remotely from the vehicle system 102. The off-board signaling device 110 may also include a transceiver 122, an antenna 124, and associated circuitry and software. The off-board signaling device 110 may be located at a command dispatch, on another vehicle system, at various route locations, or the like, within range of the remote wireless communication devices 106. The off-board signaling device 110 communicates with the remote wireless communication devices 106 by sending remote data signals.

The remote data signals may contain embedded control signals. The control signals may relate to matters that affect the operation of the vehicle system 102. For example, the control signals may warn an operator of the vehicle system 102 of a changing route condition, such as a change in the speed limit, an upcoming section of the route being occupied by another vehicle system, an upcoming section of the route being damages, and the like. The remote data signals communicated from the off-board signaling device 110 may be useful along congested areas of the route, such as in urban areas.

In an embodiment, the remote data signals may be positive train control (PTC) signals. For example, the off-board signaling device 110 may be a wayside transponder installed at various block points and/or route locations that send PTC signals to the vehicle system 102 when the vehicle system 102 is near (e.g., within a designated range) to the wayside transponder. The PTC signals may warn of a change in an authorized speed limit for an upcoming section of the route. The remote wireless communication devices 106 on the propulsion-generating vehicles 104 receive the PTC signals. In response, the propulsion-generating vehicles 104 may autonomously adjust tractive efforts and/or braking efforts according to the communicated speed limit. Furthermore, the propulsion-generating vehicles 104 may adjust the tractive effort by coordinating efforts using the local wireless communication devices 108 to communicate local data signals, as described below.

The local data signals are communicated between propulsion-generating vehicles 104 on the vehicle system 102. The local data signals may contain embedded control signals to coordinate tractive efforts and braking efforts among the propulsion-generating vehicles 104. The control signals may be transmitted and received in the form of voice messages or data messages. The control signals may relate to functions local to the vehicle system 102, such as operational control signals used to direct the tractive and braking efforts of the propulsion-generating vehicles 104 and safety control signals used to stop movement of the propulsion-generating vehicles 104 when one or more safety regulations are violated. Additional local data signals may include confirmation signals sent to acknowledge receipt of a received control signal and status signals sent to communicate a current status of a propulsion-generating vehicles 104 and operating parameters of machinery thereof (e.g., the actual power outputs generated by other propulsion-generating vehicles, lubricant and/or water temperatures, and the like). In an embodiment, the local data signals may be DP signals sent between lead and remote units to allocate power outputs for tractive and braking efforts among the propulsion-generating vehicles 104 on the vehicle system 102 when the total power output is distributed.

The local wireless communication devices 108 are disposed onboard the propulsion-generating vehicles 104, and are configured to communicate local data signals between the propulsion-generating vehicles 104 in the vehicle system 102. The local wireless devices 108 each include a transceiver 114, an antenna 116, and associated circuitry and software, which allow the local wireless devices 108 to both send and receive wireless signals, such as through RF links and the like. The local wireless devices 108 include a bandwidth which allows the local data signals to be transmitted on various frequencies and channels, which allows for simultaneous transmission of multiple control signals. For example, the remote data signals may be transmitted at medium frequency ranges (e.g., around 300 kHz-3 MHz) and high frequency ranges (e.g., around 3-30 MHz) to allow for such transmission between propulsion-generating vehicles 104 that may be spaced up to a mile or more apart along the vehicle system 102. In an embodiment, the local wireless device 108 may be a radio device.

In an embodiment, remote and local data signals may be transmitted simultaneously using different frequencies, channels, or timing patterns, among others. For example, remote data signals for off-board communications may be transmitted along a bandwidth at higher frequencies than the local data signals are transmitted for onboard communications. In an embodiment, the remote wireless device 106 may be configured with a larger bandwidth than the local wireless device 108 on a propulsion-generating vehicle 104. Therefore, even if the bandwidth of the local wireless device 108 is congested, the remote wireless communication device 106 may be able to communicate at frequencies beyond the range of the local wireless device 108 (e.g., at frequencies above the upper limit of the local wireless communication device available bandwidth).

The local wireless communication devices 108 may transmit DP control signals among the propulsion-generating vehicles 104. For example, the propulsion-generating vehicle 104 designated as lead unit 104A may send a control signal to change tractive effort provided by one or more designated remote units 104C-D. The local wireless communication device 108 on the lead unit 104A may send a series of such control signals to ensure the receipt by the local wireless communication devices 108 on the remote units 104C-D. Upon receipt, the remote units 104C-D may be configured to implement the control signals and use the local wireless communication devices 108 to send confirmation signals back to the lead unit 104A. For example, the control signal may have originally been sent by the off-board signaling device 110 as a remote data signal received by the remote wireless communication device 106 on the lead unit 104A, and transmitted to the remote units 104C-D as a local data signal using the local wireless communication devices 108.

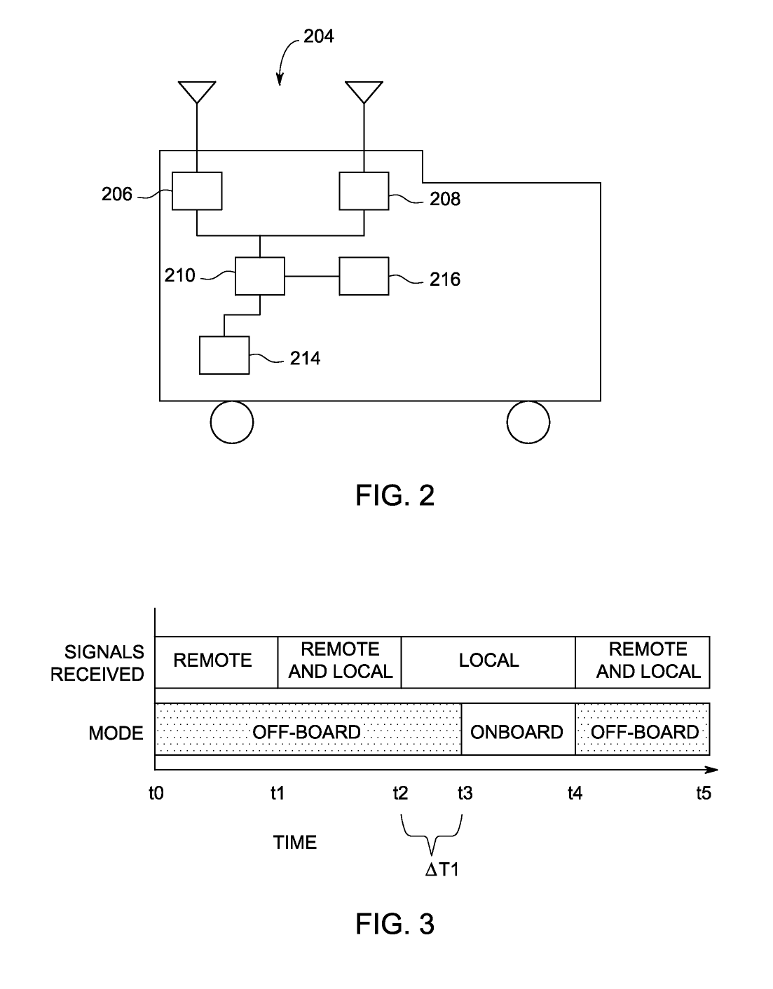

FIG. 2 schematically illustrates a propulsion-generating vehicle 204 in accordance with an embodiment. The propulsion-generating vehicle 204 may represent one or more of the propulsion-generating vehicles 104 (shown in FIG. 1) disposed on the vehicle system 102. The propulsion-generating vehicle 204 includes both a remote wireless communication device 206 and a local wireless communication device 208 located onboard the vehicle 204. The remote and local wireless communication devices 206, 208 may represent the respective remote and local wireless communication device 106, 108 (both shown in FIG. 1). The propulsion-generating vehicle 204 also includes a controller 210 operatively and electrically connected to the remote and local wireless communication devices 206, 208. The controller 210 may also be operatively and electrically connected to a propulsion system 214 on the propulsion-generating vehicle 204. Additionally, the controller 210 may connect to one or more input and/or output devices 216 (“Input/Output 216” in FIG. 2) onboard the vehicle 204.

The propulsion system 214 can represent one or more engines, motors, brakes, batteries, cooling systems (e.g., radiators, fans, etc.), and the like, that operate to generate power and propel the vehicle system 102. For example, the propulsion system 214 supplies motive power to propel the vehicle system 102 during a tractive effort, and supplies braking power to slow the vehicle system 102 during a braking effort. The type and amount of power for the propulsion system 214 to supply is controlled by the controller 210. One or more propulsion systems 214 may be provided onboard the propulsion-generating vehicle 204.

The input and/or output devices 216 may include one or more keyboards, throttles, switches, buttons, pedals, microphones, speakers, displays, and the like. The input and/or output devices 216 may be used by an operator to provide input and/or monitor output of one or more systems of the vehicle system 102. For example, a display may show an operator a readout of a received control signal, a sent control signal, and/or an activity of the propulsion system 214 in response to a control signal. This information may also be sent to a remote location, such as at a dispatch, where the information is shown on a remote display. The devices 216 may include a user interface configured to receive input control signals from an operator in the propulsion-generating vehicle 204. For example, the operator may use the user interface to increase the velocity of the vehicle system 102. The input command on the user interface is conveyed to the controller 210, which carries out the command by, for example, conveying a control signal to the propulsion system 214 to increase tractive efforts.

The controller 210 is configured to control operations of the vehicle system 102. A vehicle system or consist may include only a single propulsion-generating vehicle that includes the controller 210 as described herein. The other propulsion-generating vehicles in the vehicle system and/or consist may be controlled based on instructions received from the propulsion-generating vehicle 204 that has the controller 210. Alternatively, several propulsion-generating vehicles 204 may include the controllers 210 and assigned priorities among the controllers 210 may be used to determine which controller 210 controls operations of the propulsion-generating vehicles 204. For example, an overall vehicle control system may include two or more of the controllers 210 disposed onboard different propulsion-generating vehicles 204 that communicate with each other to coordinate operations of the vehicles 204 as described herein.

The controller 210 performs various operations. The controller 210 may represent a hardware and/or software system that operates to perform one or more functions described herein. For example, the controller 210 may include one or more computer processor(s) or other logic-based device(s) that perform operations based on instructions stored on a tangible and non-transitory computer readable storage medium. Alternatively, the controller 210 may include one or more hard-wired devices that perform operations based on hard-wired logic of the devices. The controller 210 shown in FIG. 2 may represent the hardware that operates based on software or hardwired instructions, the software that directs hardware to perform the operations, or a combination thereof.

As illustrated in FIG. 2, the controller 210 may operatively and electrically connect to wireless communication devices 206, 208, the propulsion system 212, and the input and/or output devices 216, among other systems and devices, on the propulsion-generating vehicle 204. The controller 210 also controls the propagation of control signals between these devices and systems. In one embodiment, the controller 210 may receive signals from the remote wireless communication device 206, the local wireless communication device 208, and the input devices 216, among others. After receiving the signals, the controller 210 then determines a proper course of action, which could be based on a control algorithm. The control algorithm may assign priorities to received control signals, such that for example direct inputs from the input devices 216 take precedent over received remote control signals, which take precedent over received local control signals. Proper courses of action for the controller 210 in response to control signals could include having the remote wireless communication device 206 and/or the local wireless communication device 208 transmit data signals, ordering the propulsion system 214 to increase or decrease tractive or braking efforts, and/or displaying the determined course of action on the output devices 216, among others.

For example, when a remote data signal is received by the remote wireless communication device 206, the communication device 206 conveys the signal to the controller 210. In response, if the remote data signal is a control signal to decrease the speed of the vehicle system 202, the controller 210 is configured to signal the propulsion system 214 to increase braking efforts accordingly. In addition, the controller 210 may display the current speed of the vehicle system 202 or other information on a display output device 216 for an operator to view. Furthermore, the controller 210 may control the remote wireless communication device 206 to send a confirmation signal back to the off-board location that was the source of the remote data signal. The controller 210 may also control the local wireless communication device 208 to send local data signals to other propulsion-generating vehicles 204 on the vehicle system 202 with a control signal to also increase braking efforts.

In another example, when the controller 210 receives a local control signal from either the remote wireless communication device 206 or the local wireless communication device 208, the controller 210 may be configured, among other actions, to change one or more tractive or braking efforts of the propulsion system 214 on the propulsion-generating vehicle 204 in response to the control signal. In addition, the controller 210 may be configured to use the wireless communication devices 206, 208 to coordinate the tractive or braking efforts of the propulsion-generating vehicle 204 with other propulsion-generating vehicles and/or consists in the vehicle system 202.

In one embodiment, the remote wireless communication device 206 may be configured to communicate both remote data signals and local data signals. When the remote device 206 communicates remote data signals transmitted between the vehicle system 202 and an off-board location, the remote device 206 may be referred to as operating in an off-board communication mode. When the remote device 206 communicates local data signals between the propulsion-generating vehicles 204 of the vehicle system 202, the remote device 206 is operating in an onboard communication mode.

The off and onboard communication modes may or may not be exclusive. For example, in one embodiment, when the remote device 206 functions in the off-board mode it only communicates remote data signals, not local signals, and when the remote device 206 functions in the onboard mode it only communicates local signals, not remote signals until the mode switches. In other embodiments, the modes may not be exclusive and the remote device 206 may be configured to communicate both local and remote signals concurrently in one or either mode. For example, the communications may be interleaved or multiplexed, or the remote device 206 may have multiple transceivers to allow for concurrent signal communication.

The remote wireless communication device 206 may be controlled to switch between off-board and onboard communication modes. In one embodiment, when the remote wireless communication device 206 is in the off-board communication mode, the local data signals are transmitted between propulsion-generating vehicles 204 using the local wireless communication device 208 only. As such, the local data signals are transmitted on frequencies within the defined bandwidth of the local wireless communication device 208. Switching the remote wireless communication device 206 to the onboard mode augments the available bandwidth used to communicate local data signals for the vehicle system 202. For example, the remote wireless communication device 206 may have a wider bandwidth than the local wireless communication device 208 which allows the remote device 206 to communicate local signals at frequencies beyond the frequency range of the local device 208, such as at higher frequencies. As another example, the remote wireless communication device 206 may communicate local signals at different RF channels and/or at different timing patterns than the local wireless communication device 208. Therefore, local data signals may be transmitted between propulsion-generating vehicles 204 over a “separate path” using the remote wireless communication device 206, which eases bandwidth congestion.

As a result of relieved bandwidth congestion, additional and/or more complex local data signals may be transmitted when the remote wireless communication device 206 operates in the onboard mode. For example, with an increased bandwidth for local signals, each propulsion-designated vehicle 206 designated as a remote unit in a DP system may be able to send additional remote signals to the lead unit. If the lead unit were to request status updates, now each remote unit would be able to transmit its own status and also the statuses it has received from other remote units. The result would be less communication failure between the lead and remote units.

The controller 210, in an embodiment, is configured to control the switching of the remote wireless communication device 206 between the off-board and onboard communication modes. As such, the controller 210 determines whether the remote wireless communication device 206 communicates local data signals or remote data signals. The determination to switch may be based on a programmed setting in the controller 210, operator input through an input device 216, receipt of a signal to switch, and the like, as described herein.

When the remote wireless communication device 206 is in the onboard communication mode, both of the wireless communication devices 206, 208 are configured to receive and send local data signals. The types of local data signals communicated by each of the wireless communication devices 206, 208 may be the same or different. For example, the remote wireless communication device 206 may transmit a first type of local data signal while the local wireless communication device 208 transmits a second type, and each type may be used by the controller 210 to control different operations of the propulsion-generating vehicle 204. The controller 210 may be configured to determine which local data signals are transmitted by each wireless communication device 206 and 208 based on factors, such as the importance, size, and other characteristics of the local data signals to be transmitted, and the available bandwidth of the communication devices 206, 208 at the time.

For example, if the received local data signal contains a safety control signal (used to stop movement of the propulsion-generating vehicles 204 when one or more safety regulations are violated), the controller 210 may assign both wireless communication devices 206, 208 to communicate the safety control signal to other propulsion-generating vehicles 204 to enhance the propagation of the signal throughout the vehicle system 202 and lead to a quicker response time (e.g., stoppage time). However, if the received local data signal contains an operational control signal (e.g. increase tractive efforts), determined not to be as important as a safety control signal, the controller 210 may be configured to assign only the local wireless communication device 208 to further transmit the operational control signal. The remote wireless communication device 206 then has more bandwidth available to transmit potential upcoming received local and/or remote data signals.

In another example, if the received local data signal is determined to be large or complex (e.g., greater than a threshold data packet size or message size), the controller 210 may assign the remote wireless communication device 206 to transmit the signal when the remote device 206 is in the onboard communication mode because the remote device 206 may have extra bandwidth on which to transfer the large/complex signal. Conversely, if the received local data signal is small or simple (e.g., no larger than the threshold data packet size), the controller 210 may be configured to have the local wireless communication device 208 transmit the signal even if the remote wireless communication device 206 is in the onboard mode, because the extra bandwidth is not necessary in this situation.

The remote wireless communication device 206 is configured with the operative ability to receive and send signals within a range of up to 40 miles or more. In order to communicate at such large ranges, the remote wireless communication device 206 transmits data signals at a relatively large signal intensity. However, when the remote wireless communication device 206 operates in the onboard communication mode to transmit local data signals on the vehicle system 202, the range from the device 206 to the intended receivers of the signals (e.g., other propulsion-generating vehicles 204 on the same vehicle system 202) is much shorter, on the order of a less than a mile to a couple miles. Therefore, in an embodiment, the controller 210 is configured to reduce the transmission signal intensity of the remote wireless communication device 206 when the wireless device 206 switches from off-board to onboard communication mode. The transmission signal intensity is reduced because local data signals are generally only relevant to the vehicle system 202 itself. Transmitting local data signals with the same intensity as remote data signals would unnecessarily clog the RF airwaves, reducing the available bandwidth for other vehicle systems in the remote proximity.

FIG. 3 illustrates a timing diagram for operating the remote wireless communication device 206 according to one embodiment. The diagram shows modes of operation and signals received using the remote wireless communication device 206. In an embodiment, the remote wireless communication device 206 may switch between operating in the off-board communication mode and the onboard communication mode. The controller 210 may be configured to control the remote wireless communication device 206 and switch between the off-board and onboard communication modes.

Since both local and remote data signals may be received by the remote wireless communication device 206 within a common time period, the determination between operating in off-board communication mode and onboard communication mode in such a situation may be based on assigned priorities. The controller thereafter uses the assigned priorities to cause the propulsion-generating vehicle 204 to operate according to the remote data signals or the local data signals, whichever has priority.

In an embodiment, the remote data signals are assigned a higher priority than the local data signals, so the remote wireless communication device 206 operates by default in the off-board communication mode. The remote data signals may be assigned priority because the remote signals may relate to emergency safety issues, such as a stalled vehicle in the route ahead, while the messages relayed by the local signals may not generally have similar safety implications. For example, the remote data signals may be PTC signals sent from a remote dispatch monitoring the statuses of many vehicle systems, so the remote signals could implicate safety considerations beyond the local vehicle system.

The remote wireless communication device 206 may be controlled to send and receive signals that are assigned a lower priority in certain prescribed situations. For example, even though remote data signals may be assigned priority over local data signals such that the remote wireless communication device 206 operates by default in off-board communication mode, the controller 210 may switch the remote device 206 to the onboard communication mode in certain prescribed situations. Such prescribed situations may include non-receipt of the priority data signals for a set period of time, operator input, and/or receipt of a priority signal commanding the switch, among others. Thus, in one embodiment, after non-receipt of remote data signals for at least a designated time period, the controller 210 may direct the remote wireless communication device 206 to switch from the off-board communication mode to the onboard communication mode. Once in the onboard communication mode, the remote wireless communication device 206 supplements and augments an available bandwidth for transmitting local data signals between propulsion-generating vehicles 204 on the vehicle system.

In another example, the controller 210 may be configured to direct the remote wireless communication device 206 to switch from the off-board communication mode to the onboard mode upon identifying an operating failure of the local wireless communication device 208 on board the propulsion-generating vehicle 204. Therefore, if the local wireless communication device 208 is inoperable or malfunctioning, such as due to a damaged antenna, transceiver, or a flaw in the associated software and/or circuitry, the remote wireless communication device 206 may act in place of the inoperable local device 208 by communicating local data signals, such as DP signals.

In one embodiment, even while the remote wireless communication device 206 transmits low-priority data signals, the remote device 206 continues to “listen” for high-priority signals. Once a high-priority data signal is received, the remote wireless communication device 206 may be controlled to switch communication modes in order to transmit the newly-received high-priority data signal. For example, continuing the example above, once the remote wireless communication device 206 receives a remote data signal, the remote device 206 conveys the signal to the controller 210, and the controller 210 switches the remote device 206 back to the off-board communication mode in order to transmit the received remote data signal.

An example process that shows the types of signals received by the remote wireless communication device 206 and the communication mode of the remote device 206 over a period of time is shown in FIG. 3. In the diagram, remote data signals take priority over local data signals, so the default communication mode is off-board. From time t0 to t1, only remote data signals are received by the remote wireless communication device 206, so the remote device is controlled to operate in the off-board mode to transmit the remote signals. From time t1 to t2, local data signals are also received along with remote data signals, but since the remote data signals have an assigned priority over the local data signals, the remote wireless communication mode continues to operate in the off-board mode, and does not transmit the received local data signals. From time t2 to t3, or ΔT1, only local data signals are received but the communication mode does not switch to onboard yet because ΔT1 represents a designated time period of non-receipt of priority signals before the controller 210 switches communication modes. Thereafter, the communication mode switches at time t3 to the onboard mode, and from time t3 to t4 the remote wireless communication mode augments the available bandwidth to transfer local data signals. Finally, at time t4 another remote data signal is received by the remote wireless communication device 206, and the controller 210 automatically switches communication modes back to the off-board mode in order to transfer the received remote signals according to the assigned priority.

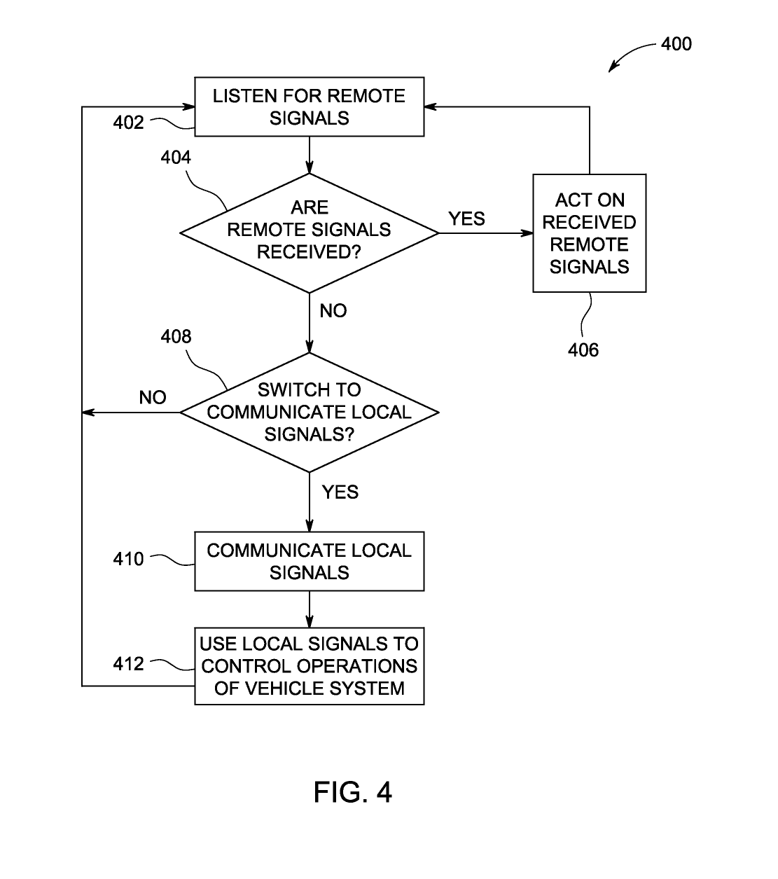

FIG. 4 illustrates a flowchart of one embodiment of a method 400 of communicating signals for vehicle system 102. The method 400 is described in connection with the vehicle system 102 as shown in FIG. 1 described herein. At 402, as the vehicle system 102 travels along the route 103, the vehicle system 102 listens for remote signals. For example, the remote wireless communication device 106 disposed onboard one or more of the propulsion-generating vehicles 104 listens for remote data signals being transmitted from locations off-board the vehicle system 102, such as PTC signals sent from a dispatch location.

At 404, a determination is made as to whether remote signals are being received. For example, any remote signals received by the remote wireless communication device 106 may be conveyed to the controller 210 (shown in FIG. 2) for further action in response to the received remote signal. The remote signal may be related to a safety concern, so the vehicle system 102 may be configured to take prompt action to implement any messages received via remote signals. If the vehicle system 102 has received remote signals, then flow of the method 400 may proceed to 406.

At 406, the vehicle system 102 acts on the received remote signal. The controller 210 may act by performing a variety of functions, including, for example, displaying a readout on a display of an output device 216 (shown in FIG. 2), controlling the propulsion system 214 (shown in FIG. 2) to increase or decrease tractive efforts or braking efforts, operating the local wireless communication device 108 to transmit signals (e.g., the received remote signal and/or additional signals) to other communication devices on the vehicle system 102, and operating the remote wireless communication device 106 to send a response signal back to the source of the received remote signal. After acting on the received remote signal, flow of the method may return to 402 where the remote wireless communication device 106 continues to listen for remote signals.

Referring again back to 404, if the vehicle system 102 has not received remote signals, then flow of the method 400 may proceed to 408. At 408, since the remote wireless communication device 106 has not recently (e.g., within the last cycle of the method 400) received a remote signal, a determination is made as to whether the communication device 106 should switch to communicate local signals. If no remote signals are being received, the remote wireless communication device 106 may be used to supplement the local wireless communication device 108 communicating local data signals between the propulsion-generating vehicles 104 of the vehicle system 102. However, it may not be desirable to always switch the remote wireless communication device 106 upon every determination that remote signals have not been received, as such operation could result in frequent switching which could exhaust and/or damage the controller 210, wireless device 106, and other associated hardware.

In an embodiment of the method 400, the controller 210 may determine to switch the remote wireless communication device 106 to communicate local signals after a designated time period of non-receipt of remote signals. In this embodiment, if the amount of time from the last received remote data signal to the present time does not meet or exceed the designated time period, the determination to switch is determined in the negative. The determination whether to switch or not may also be controlled by an operator's input, a received command signal, and the like. When the determination to switch at 408 is negative, the flow of the method 400 returns to 402 to listen for remote signals. When the determination to switch at 408 is positive, such as if the designated time period of non-receipt has been met, for example, the flow of the method proceeds to 410.

At 410, the remote wireless communication device 106 is directed to communicate local signals. Although local signals may have a lower assigned priority than remote signals, since no remote signals have been received, the remote communication device 106 may be used to supplement the local wireless communication device 108, at least until higher priority remote signals are received. Using the remote communication device 106 to communicate local signals between propulsion-generating vehicles 104 disposed along the vehicle system 102 may relieve transmission congestion and free up bandwidth for additional signals that may reduce the number of messages that get lost in transmission. The controller 210 may coordinate the transmission of local signals, such as DP signals, between the remote and local communication devices 106, 108. After the local signals are communicated at 410 using the remote wireless communication device 106 and/or the local wireless communication device 108, the flow of the method 400 proceeds to 412.

At 412, the transmitted local signals are used to control operations of the vehicle system 102. For example, the local signals may be DP signals transmitted from a propulsion-generating vehicle 104 acting as a lead unit to one or more remote units in order to coordinate a total power output by allocating certain desired power outputs to the remote unit(s). After the remote wireless communication device 106 has communicated the local signals at 410, and the local signals have been implemented to control operations of the vehicle system 102 at 412, the flow of the method 400 returns to 402 so the remote communication device can listen for remote signals 402. If no remote signals are received at 404, then once again the determination may be made at 408 to have the remote communication device 106 communicate local data signals since, for example, the time period since last receipt of remote signals will still exceed the designate time period.

In one embodiment, a communication system includes a first wireless communication device and a controller. The first wireless communication device is configured to be disposed onboard a vehicle system having two or more propulsion-generating vehicles that are mechanically interconnected with each other in order to travel along a route together. The controller is configured to be disposed onboard the vehicle system and operatively connected with the first wireless communication device in order to control operations of the first wireless communication device. The controller is configured to direct the first wireless communication device to switch between operating in an off-board communication mode and operating in an onboard communication mode. When the first wireless communication device is operating in the off-board communication mode, the first wireless communication device is configured to receive remote data signals from a location that is disposed off-board of the vehicle system. When the first wireless communication device is operating in the onboard communication mode, the first wireless communication device is configured to communicate local data signals between the propulsion-generating vehicles of the vehicle system.

In one aspect, the remote data signals that are communicated from the location that is off-board of the vehicle system are control signals. The first wireless communication device is configured to receive the control signals and convey the control signals to the controller. The controller is configured to change one or more tractive efforts or braking efforts of the vehicle system in response to the control signals.

In one aspect, the control signals are PTC signals.

In one aspect, the local data signals that are communicated between the propulsion-generating vehicles are control signals. The first wireless communication device is configured to receive the control signals and convey the control signals to the controller. The controller is configured to coordinate one or more tractive efforts or braking efforts of the two or more propulsion-generating vehicles according to the control signals.

In one aspect, the control signals are DP signals.

In one aspect, the first wireless communication device is configured to receive both the remote data signals and the local data signals during a common time period. The controller is configured to cause the propulsion-generating vehicles to operate according to the remote data signals or the local data signals according to priorities assigned to the remote data signals and the local data signals.

In one aspect, the remote data signals are assigned with higher priorities than the local data signals.

In one aspect, the controller is configured to direct the first wireless communication device to switch from the off-board communication mode to the onboard communication mode after non-receipt of the remote data signals for at least a designated time period.

In one aspect, the first wireless communication device is a radio device.

In one aspect, a second wireless communication device is configured to communicate the local data signals between the propulsion-generating vehicles of the vehicle system so that the controller can coordinate one or more tractive efforts or braking efforts of the propulsion-generating vehicles with each other. The controller is configured to direct the first wireless communication device to switch to the onboard communication mode to augment an available bandwidth that is used to communicate the local data signals for the vehicle system.

In one aspect, the local data signals include operational control signals and safety control signals. The operational control signals are used to direct the one or more tractive efforts or braking efforts of the propulsion-generating vehicles. The safety control signals are used to stop movement of the propulsion-generating vehicles when one or more safety regulations are violated. The second wireless communication device is configured to communicate the operational control signals. The controller is configured to direct both the first wireless communication device and the second wireless communication device to communicate the safety control signals when the first wireless communication device is in the onboard mode of operation.

In one aspect, the controller is configured to direct the first wireless communication device to communicate the local data signals that are larger than a threshold data packet size when the first wireless communication device is in the onboard mode of operation. Meanwhile, the second wireless communication device is configured to communicate the local data signals that are no larger than the threshold data packet size.

In one aspect, the controller is configured to direct the first wireless communication device to communicate the local data signals of a first type when the first wireless communication device is in the onboard mode of operation. Meanwhile the second wireless communication device is configured to communicate the local data signals of a different, second type. The first and second types of the local data signals are used to control respective different operations of the propulsion-generating vehicles.

In one aspect, the vehicle system includes two or more vehicle consists with the propulsion-generating vehicles disposed in different ones of the vehicle consists. The controller is configured to direct the first wireless communication device to communicate the local data signals between the different vehicle consists.

In one aspect, the controller is configured to reduce a signal intensity at which the first wireless communication device transmits the local control signals responsive to the first wireless communication device being switched from the off-board communication mode to the onboard communication mode.

In one embodiment, a method includes directing a first wireless communication device configured to be disposed onboard a vehicle system to operate in an off-board communication mode. The vehicle system has two or more propulsion-generating vehicles that are mechanically interconnected with each other in order to travel along a route together. In the off-board communication mode, the first wireless communication device is configured to receive remote data signals from a location that is disposed off-board the vehicle system. The method also includes switching the first wireless communication device from operating in the off-board communication mode to operating in an onboard communication mode. In the onboard communication mode, the first wireless communication device is configured to communicate local data signals between the propulsion-generating vehicles of the vehicle system. The method further includes controlling movement of the vehicle system responsive to receipt of the remote data signals and responsive to receipt of the local data signals.

In one aspect, the first wireless communication device is configured to receive both the remote data signals and the local data signals during a common time period. Control of the propulsion-generating vehicles of the vehicle system is responsive to the remote data signals or the local data signals according to priorities assigned to the remote data signals and the local data signals.

In one aspect, the remote data signals are assigned with higher priorities than the local data signals.

In one aspect, switching the first wireless communication device to the onboard communication mode augments an available bandwidth that is used to communicate the local data signals for the vehicle system.

In one aspect, switching the first wireless communication device from the off-board communication mode to the onboard communication mode includes reducing a signal intensity at which the first wireless communication device transmits the local control signals.

In one embodiment, a communication system includes a controller. The controller is configured to be disposed onboard a vehicle system having two or more propulsion-generating vehicles that are mechanically interconnected with each other in order to travel along a route together. The controller is configured to operatively connect with the propulsion-generating vehicles and a first wireless communication device. The controller is configured to direct the first wireless communication device to switch between operating in an off-board communication mode and operating in an onboard communication mode. In the off-board communication mode, the first wireless communication device is configured to receive remote data signals from a location that is disposed off-board of the vehicle system. In the onboard communication mode, the first wireless communication device is configured to communicate local data signals between the propulsion-generating vehicles of the vehicle system.

In one aspect, the remote data signals that are communicated from the location that is off-board of the vehicle system are control signals. The first wireless communication device is configured to receive the control signals and convey the control signals to the controller. The controller is configured to change one or more tractive efforts or braking efforts of the vehicle system in response to the control signals.

In one aspect, the control signals are PTC signals.

In one aspect, the local data signals that are communicated between the propulsion-generating vehicles are control signals. The first wireless communication device is configured to receive the control signals and convey the control signals to the controller. The controller is configured to coordinate one or more tractive efforts or braking efforts of the two or more propulsion-generating vehicles according to the control signals.

In one aspect, the control signals are DP signals.

In one aspect, the first wireless communication device is configured to receive both the remote data signals and the local data signals during a common time period. The controller is configured to cause the propulsion-generating vehicles to operate according to the remote data signals or the local data signals according to priorities assigned to the remote data signals and the local data signals.

In one aspect, the remote data signals are assigned with higher priorities than the local data signals.

In one aspect, the controller is configured to direct the first wireless communication device to switch from the off-board communication mode to the onboard communication mode after non-receipt of the remote data signals for at least a designated time period.

In one aspect, the controller is configured to direct the first wireless communication device to switch to the onboard communication mode to augment an available bandwidth that is used to communicate the local data signals between the propulsion-generating vehicles of the vehicle system.

In one embodiment, a communication system includes a first wireless communication device configured to be disposed onboard a vehicle system. The vehicle system has two or more propulsion-generating vehicles that are mechanically interconnected with each other in order to travel along a route together. The first wireless communication device configured to switch between operating in an off-board communication mode and operating in an onboard communication mode. When the first wireless communication device is operating in the off-board communication mode, the first wireless device is configured to receive remote data signals from a location that is disposed off-board of the vehicle system. When the first wireless communication device is operating in the onboard communication mode, the first wireless communication device is configured to communicate local data signals between the propulsion-generating vehicles of the vehicle system.

In one aspect, the first wireless communication device is configured to operatively connect to a controller disposed onboard the vehicle system. The controller is configured to direct the first wireless communication device to switch from the off-board communication mode to the onboard communication mode after non-receipt of the remote data signals for at least a designated time period.

In one aspect, the first wireless communication device is a radio device.

In one aspect, the communication system also includes a second wireless communication device configured to communicate the local data signals between the propulsion-generating vehicles of the vehicle system through an available bandwidth. The first wireless communication device is configured to switch to the onboard communication mode to augment the available bandwidth to communicate the local data signals.

In one aspect, the local data signals include operational control signals and safety control signals. The operational control signals are used to direct the one or more tractive efforts or braking efforts of the propulsion-generating vehicles. The safety control signals are used to stop movement of the propulsion-generating vehicles when one or more safety regulations are violated. The second wireless communication device is configured to communicate the operational control signals. Both the first wireless communication device and the second wireless communication device are configured to communicate the safety control signals when the first wireless communication device is in the onboard mode of operation.

In one aspect, the first wireless communication device is configured to communicate the local data signals that are larger than a threshold data packet size when the first wireless communication device is in the onboard mode of operation. Meanwhile, the second wireless communication device is configured to communicate the local data signals that are no larger than the threshold data packet size.

In one aspect, the first wireless communication device is configured to communicate the local data signals of a first type when the first wireless communication device is in the onboard mode of operation. Meanwhile, the second wireless communication device is configured to communicate the local data signals of a different, second type. The first and second types of the local data signals are used to control respective different operations of the propulsion-generating vehicles.

In one aspect, the vehicle system includes two or more vehicle consists with the propulsion-generating vehicles disposed in different ones of the vehicle consists. The first wireless communication device is configured to communicate the local data signals between the different vehicle consists.

In one aspect, the first wireless communication device is configured to transmit the local control signals at a reduced signal intensity compared to the signal intensity used to transmit remote data signals.

In one embodiment, a communication system includes a radio deployed onboard a first rail vehicle of a rail vehicle consist and operative in a first mode of operation and a second mode of operation. The radio is configured when operating in the first mode of operation to communicate at least one of voice signals or data signals between the first rail vehicle and a location off-board the rail vehicle consist using a first frequency bandwidth. The radio is configured when operating in the second mode of operating to wirelessly communicate distributed power signals from the first rail vehicle to one or more remote rail vehicles in the rail vehicle consist using a different, second frequency bandwidth, for at least one of augmenting operating of other onboard wireless devices that are configured to communicate the distributed power signals in the rail vehicle consist or for acting in place of at least one of the other onboard wireless devices.

In one aspect, the radio is configured to automatically operate in the second mode of operation when the radio is not operating in the first mode of operation to communicate the at least one of the voice signals or the data signals from between the first rail vehicle and the location off-board the rail vehicle consist.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described systems and methods without departing from the spirit and scope of the inventive subject matter herein involved, it is intended that all of the subject matter of the above description or shown in the accompanying drawings shall be interpreted merely as examples illustrating the inventive concept herein and shall not be construed as limiting the inventive subject matter.

What is claimed is:

1. A communication system comprising:
a first wireless communication device configured to be disposed onboard a vehicle system having two or more propulsion-generating vehicles that are mechanically interconnected with each other in order to travel along a route together; and
a controller configured to be disposed onboard the vehicle system and operatively connected with the first wireless communication device in order to control operations of the first wireless communication device, the controller configured to direct the first wireless communication device to switch between operating in an off-board communication mode and operating in an onboard communication mode,
wherein, when the first wireless communication device is operating in the off-board communication mode, the first wireless communication device is configured to receive remote data signals from a location that is disposed off-board of the vehicle system and, when the first wireless communication device is operating in the onboard communication mode, the first wireless communication device is configured to communicate local data signals between the propulsion-generating vehicles of the vehicle system.

2. The communication system of claim 1, wherein the remote data signals that are communicated from the location that is off-board of the vehicle system are control signals, and the first wireless communication device is configured to receive the control signals and convey the control signals to the controller, and the controller is configured to change one or more tractive efforts or braking efforts of the vehicle system in response to the control signals.

3. The communication system of claim 2, wherein the control signals are positive train control (PTC) signals.

4. The communication system of claim 1, wherein the local data signals that are communicated between the propulsion-generating vehicles are control signals, and the first wireless communication device is configured to receive the control signals and convey the control signals to the controller, and the controller is configured to coordinate one or more tractive efforts or braking efforts of the two or more propulsion-generating vehicles according to the control signals.

5. The communication system of claim 4, wherein the control signals are distributed power (DP) signals.

6. The communication system of claim 1, wherein the first wireless communication device is configured to receive both the remote data signals and the local data signals during a common time period, and the controller is configured to cause the propulsion-generating vehicles to operate according to the remote data signals or the local data signals according to priorities assigned to the remote data signals and the local data signals.

7. The communication system of claim 6, wherein the remote data signals are assigned with higher priorities than the local data signals.

8. The communication system of claim 1, wherein the controller is configured to direct the first wireless communication device to switch from the off-board communication mode to the onboard communication mode after non-receipt of the remote data signals for at least a designated time period.

9. The communication system of claim 1, wherein the first wireless communication device is a radio device.

10. The communication system of claim 1, further comprising a second wireless communication device configured to communicate the local data signals between the propulsion-generating vehicles of the vehicle system so that the controller can coordinate one or more tractive efforts or braking efforts of the propulsion-generating vehicles with each other, the controller configured to direct the first wireless communication device to switch to the onboard communication mode to augment an available bandwidth that is used to communicate the local data signals for the vehicle system.

11. The communication system of claim 10, wherein the local data signals include operational control signals and safety control signals, the operational control signals used to direct the one or more tractive efforts or braking efforts of the propulsion-generating vehicles, the safety control signals used to stop movement of the propulsion-generating vehicles when one or more safety regulations are violated, and
wherein the second wireless communication device is configured to communicate the operational control signals and the controller is configured to direct both the first wireless communication device and the second wireless communication device to communicate the safety control signals when the first wireless communication device is in the onboard mode of operation.

12. The communication system of claim 10, wherein the controller is configured to direct the first wireless communication device to communicate the local data signals that are larger than a threshold data packet size when the first wireless communication device is in the onboard mode of operation while the second wireless communication device is configured to communicate the local data signals that are no larger than the threshold data packet size.

13. The communication system of claim 10, wherein the controller is configured to direct the first wireless communication device to communicate the local data signals of a first type when the first wireless communication device is in the onboard mode of operation while the second wireless communication device is configured to communicate the local data signals of a different, second type, the first and second types of the local data signals used to control respective different operations of the propulsion-generating vehicles.

14. The communication system of claim 1, wherein the vehicle system includes two or more vehicle consists with the propulsion-generating vehicles disposed in different ones of the vehicle consists, and the controller is configured to direct the first wireless communication device to communicate the local data signals between the different vehicle consists.

15. The communication system of claim 1, wherein the controller is configured to reduce a signal intensity at which the first wireless communication device transmits the local control signals responsive to the first wireless communication device being switched from the off-board communication mode to the onboard communication mode.

16. A method comprising:
directing a first wireless communication device configured to be disposed onboard a vehicle system to operate in an off-board communication mode, the vehicle system having two or more propulsion-generating vehicles that are mechanically interconnected with each other in order to travel along a route together, wherein, in the off-board communication mode, the first wireless communication device is configured to receive remote data signals from a location that is disposed off-board the vehicle system;
switching the first wireless communication device from operating in the off-board communication mode to operating in an onboard communication mode, wherein, in the onboard communication mode, the first wireless communication device is configured to communicate local data signals between the propulsion-generating vehicles of the vehicle system; and
controlling movement of the vehicle system responsive to receipt of the remote data signals and responsive to receipt of the local data signals.

17. The method of claim 16, wherein switching the first wireless communication device to the onboard communication mode augments an available bandwidth that is used to communicate the local data signals for the vehicle system.

18. The method of claim 16, wherein switching the first wireless communication device from the off-board communication mode to the onboard communication mode comprises reducing a signal intensity at which the first wireless communication device transmits the local control signals.

19. A communication system comprising:
a controller configured to be disposed onboard a vehicle system having two or more propulsion-generating vehicles that are mechanically interconnected with each other in order to travel along a route together, the controller configured to operatively connect with the propulsion-generating vehicles and a first wireless communication device,
wherein the controller is configured to direct the first wireless communication device to switch between operating in an off-board communication mode and operating in an onboard communication mode,
wherein, in the off-board communication mode, the first wireless communication device is configured to receive remote data signals from a location that is disposed off-board of the vehicle system and, in the onboard communication mode, the first wireless communication device is configured to communicate local data signals between the propulsion-generating vehicles of the vehicle system.

20. The communication system of claim 19, wherein the first wireless communication device is configured to receive both the remote data signals and the local data signals during a common time period, and the controller is configured to cause the propulsion-generating vehicles to operate according to the remote data signals or the local data signals according to priorities assigned to the remote data signals and the local data signals.

21. A communication system comprising:
a radio deployed onboard a first rail vehicle of a rail vehicle consist and operative in a first mode of operation and a second mode of operation,
wherein the radio is configured when operating in the first mode of operation to communicate at least one of voice signals and data signals between the first rail vehicle and a location off-board the rail vehicle consist using a first frequency bandwidth,
and wherein the radio is configured when operating in the second mode of operation to wirelessly communicate distributed power signals from the first rail vehicle to one or more remote rail vehicles in the rail vehicle consist using a different, second frequency bandwidth, for at least one of augmenting operation of other onboard wireless devices that are configured to communicate the distributed power signals in the rail vehicle consist or for acting in place of at least one of the other onboard wireless devices.

22. The communication system of claim 21, wherein the radio is configured to automatically operate in the second mode of operation when the radio is not operating in the first mode of operation to communicate the at least one of the voice signals or the data signals from between the first rail vehicle and the location off-board the rail vehicle consist.
